(19) United States
(12) Patent Application Publication
(10) Pub. No.: US 2021/0291978 A1
(43) Pub. Date: Sep. 23, 2021

(54) FLYING BODY

(71) Applicant: AERONEXT INC., Tokyo (JP)

(72) Inventor: Yoichi Suzuki, Tokyo (JP)

(21) Appl. No.: 17/258,386

(22) PCT Filed: Jul. 20, 2018
(86) PCT No.: PCT/JP2018/027410

§ 371 Date: Jan. 6, 2021

(51) Int. Cl. B64C 39/02; B64C 25/08

(52) U.S. Cl. CPC B64C 39/02; B64C 25/08

(57) ABSTRACT

To provide a flying body in which the flight part and the main body can be detachably attached and work can be performed in each thereof. The flying body according to the present invention includes a flight part and a main body. The main body is detachably connected to the flight part so that at least the main body can be installed on the installation target surface. In addition, each of the flight part and the main body is detachably connected by a connection part that swingably connects within a predetermined range. According to this configuration, after the flying body reaches the planned activity point, only the main body equipped with a camera or the like remains in the place, and the activity can be continued independently of the flight part.

### TECHNICAL FIELD

The present invention relates to a flying body, and more particularly to a flying body that is provided with a leg part such as a tripod and is detachably configured from the leg part.

### BACKGROUND ART

In recent years, various services have been provided using a flying body such as a drone or unmanned aerial vehicle (UAV) used for various purposes. Such a flying body can fly with various working parts such as a camera or a sensor, a sound collector, a sprayer, a speaker, and the like. Hence, the range of industrial application is being further expanded.

When work is to be performed with a flying body, in many models, a working part is fixed to the upper part or the lower part of a rotary-wing aircraft. However, in that case, due to the mounting of the working part which includes a free heavy load, the balance of the rotary-wing aircraft is lost, the flight efficiency deteriorates, or the flight becomes unstable.

Meanwhile, Patent Document 1 provides a mechanism that can continue a stable flight with little difference between rotary wings, even in a rotary-wing aircraft in which a heavy load is provided vertically below the rotary-wing aircraft (see, for example, Patent Document 1).

### CITATION LIST

### Patent Literature

[Patent Document 1] International Patent Publication

### SUMMARY OF THE INVENTION

### Technical Problem

In Patent Document 1, a rotary-wing aircraft having a heavy load such as a camera is configured such that the center of lift generated in an airframe by rotating a plurality of rotary wings is positioned at a connection part between an arm part that support the rotary wing and a mounting part that mounts a heavy load. This makes it possible to continue stable flight with little difference between rotor wings.

However, when using a camera or the like provided in the flying body in Patent Document 1, the flying operation is performed at the same time and thus, electric power and fuel are continuously consumed to allow the flying body to stay in the air. In addition, the sound and wind by flight may affect the activity, and the flying body itself may be an obstacle to the activity.

Therefore, one object of the present invention is to provide a flying body in which only the main body equipped with a camera, etc. remains on the place after reaching the planned activity point, and the flight part and the main body can be detachably attached so as to continue the activity independently of the flight part, and operation can be performed operated in each thereof.

### Technical Solution

According to the present invention, there can be provided a flying body including: a flight part and a main body,

wherein the main body is detachably connected to the flight part so that at least the main body can be installed on an installation target surface.

### Advantageous Effects

According to the present disclosure, there can be provided a flying body in which the flight part and the main body can be detachably attached and work can be performed in each thereof.

### BRIEF DESCRIPTION OF THE DRAWINGS

FIG. 1 is a front view of a flying body according to the present invention.

FIG. 2 is a diagram illustrating a state during the landing of the flying body of FIG. 1.

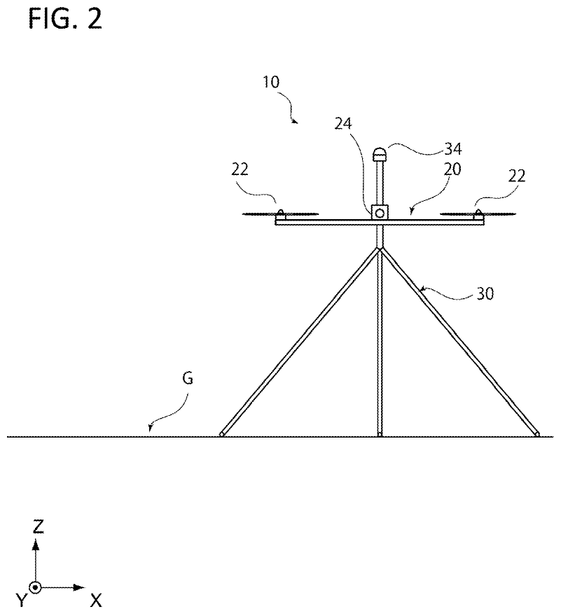

FIG. 3 is a diagram illustrating the separation between the main body and the flight part of the flying body of FIG. 1.

FIG. 4 is another side view of the flying body according to the present invention.

### DETAILED DESCRIPTION OF THE EMBODIMENTS

The contents of the embodiment of the present invention will be listed and described. According to an embodiment of the present invention, the following configuration is provided.

[Item 1]

A flying body including a flight part and a main body, wherein the main body is detachably connected to the flight part so that at least the main body can be installed on an installation target surface.

[Item 2]

The flying body as set forth in Item 1,

wherein the flight part and the main body are detachably connected by a connection part that swingably connects the flight part and the main body within a predetermined range.

[Item 3]

The flying body as set forth in Item 1 or 2,

wherein the main body includes an acquisition unit for acquiring an outside-world information.

[Item 4]

The flying body as set forth in any one of Items 1 to 3,

wherein the main body includes a leg part, and

the leg part is installed on the installation target surface.

<Details of Embodiments of the Present Invention>

Hereinafter, embodiments of the present invention will be described with reference to the accompanying figures.

<Details of First Embodiment according to the Present Invention>

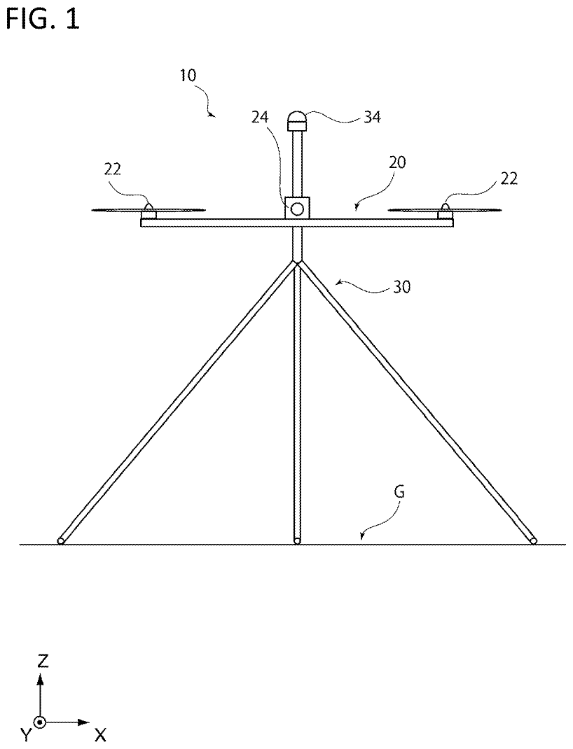

As shown in FIG. 1, the flying body 10 according to the implementation of the present invention includes a flight part 20 having at least a power part 22, a main body 30 that is detachably attached to the flight part 20, and a connection part 24 that connects the flight part 20 and the main body 30.

The main body 30 has a tripod-shaped leg part, a part extending vertically from the leg part, and a working part 34 (camera, etc.) provided at the tip of the part.

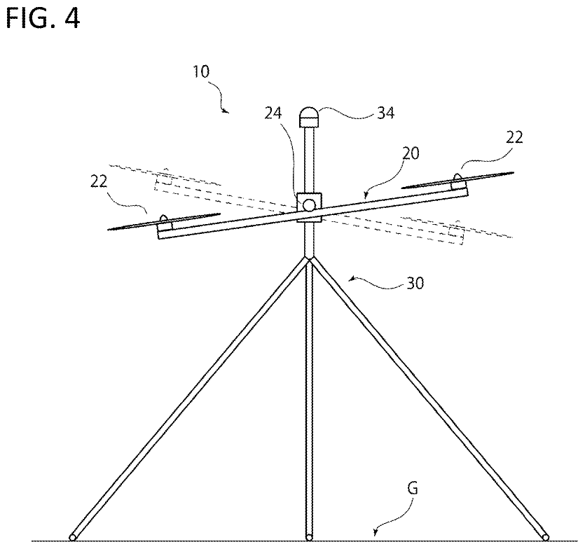

The main body 30 and the flight part 20 are connected by the connection part 24. The main body 30 and the flight part 20 according to the present embodiment are fixed to each other. However, as shown in FIG. 4, in order to allow the main body 30 to be installed at least on the installation target surface, the connection part 24 that is detachably connected to the flight part 20 may be connected so that the flight part 20 and the main body 30 is swingable to each other within a predetermined range. Thereby, the main body 30 can maintain a suitable angle with respect to the installation target surface regardless of the posture of the flight part 20.

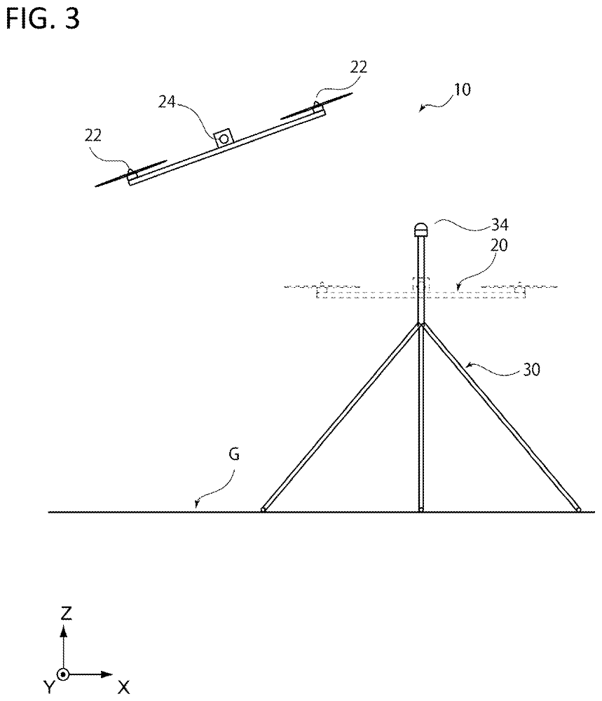

According to such a configuration, as shown in FIG. 3, after landing from the flying state, the leg part of the main body 30 are installed on ground G. After being installed on the ground, the flight part is separated from the main body 30 at the part of the connection part 24 and flies. At this time, as shown in FIG. 4, when the flight part 20 and the main body 30 are connected so as to be swingable within a predetermined range, the flight part 20 can also start flight regardless of the inclination of the main body 30 or the installation target surface.

The main body 30 includes a working part 34 and can perform work. The work parting 34 and the work performed by the working part includes, for example, photographing , monitoring, surveying, recording, etc. by information acquisition devices that can acquire an outside-world information such as cameras, sensors, and microphones, liquid spraying, painting, fire extinguishing, water sprinkling to animals and plants by a sprayer, a spraying device, and a water spray device, appealing to outside by a speaker, an odor generator, and a light emitting device, work and maintenance by a tool and a robot arm, movement of objects, and the like, without being limited thereto.

The main body 30 and the flight part 20 can be operated even in a connected state or in a disconnected state, respectively. Therefore, for example, as shown in FIG. 3, in a flying body having a main body 30 provided with an information acquisition device including a camera and a microphone in the working part 34, the flight part 20 is separated after the main body 30 is installed. Thereby, for example, this makes it difficult to be detected by the information acquisition target due to the reduced area, eliminates the reflection of the flight part 20, and/or prevents the operation noise of the power part 22 from entering, and the like.

Further, while the main body 30 performs work, the flight part 20 can perform another work or receive power. Even in the case of staying in the air and continuing to fly, since the heavy load of the main body 30 is separated, longtime flight is made possible as compared with the case of flying while connected to the main body 30.

The main body 30 may have a leg part. When the main body 30 is installed on the installation target surface, the leg part separates the installation target surface from the working part 34 provided in the main body 30, and additionally, could install the main body 30 stably. For example, if the installation target surface is at the bottom of water, the leg part can be adjusted so that the working part 34 provided in the main body 30 and the flight part 20 are located higher than the water level, thereby preventing water wetting and the like. When having a floating material in the leg part, the installation target surface itself can be made as the water surface.

The main body 30 can move without staying at the place where it is installed. For example, when equipped with means that can move on land, under water or in the air, such as wheels, caterpillars, walking mechanisms, screw propellers, and rotors, after being installed by the flying body in a place where it is difficult for people to enter, it is possible to move to a place according to the purpose and carry out activities. At disaster sites, battlefields and the like, the function capable of operating even when no one stays nearby may be made useful by a remote control and an autonomous movement.

For example, when provided with a communication device or radar, it is possible to be easily installed at the desired location, and additionally, it can move to a convenient position in operation. When the communication device is wireless and used as a disaster prevention radio, it can move in the direction in which a person stays, thereby obtaining a higher effect.

Further, the main body 30 may or may not be collected after being installed as a simple device. When equipped with a launcher (e.g., recoilless rifle, a rocket, a fougasse) or a firearm, or equipped with an explosive, it can also be disposed after installation.

The photographing device of the present invention can be expected to be used for monitoring, investigation, and other information gathering. Further, the present invention can be suitably used as a rotary-wing aircraft for photography capable of omnidirectional photography. It can also be used in various industries such as defense, security, and agriculture.

The above-described embodiment is merely an example for facilitating the understanding of the present invention and should not be construed as limiting the present invention. It goes without saying that the present invention can be modified and improved without departing from the spirit thereof, and the present invention includes an equivalent thereof.

### DESCRIPTION OF REFERENCE NUMERALS

10: flying body

20: flight part

22: power part

24: connection part

30: main body

34: working part

G: ground target surface

1-4. (canceled)

5. A flying body comprising:
a flight part; and
a main body,
wherein the main body is detachably connected to the flight part so that at least the main body can be installed on an installation target surface.

6. The flying body according to claim 5,
wherein the flight part and the main body are detachably connected by a connection part that swingably connects the flight part and the main body within a predetermined range.

7. The flying body according to claim 5,
wherein the main body includes an acquisition part for acquiring an outside-world information.

8. The flying body according to claim 6,
wherein the main body includes an acquisition part for acquiring an outside-world information.

9. The flying body according to claim 5,
wherein the main body includes a leg part, and the leg part is installed on the installation target surface.

10. The flying body according to claim 6,
wherein the main body includes a leg part, and the leg part is installed on the installation target surface.

11. The flying body according to claim 7,
wherein the main body includes a leg part, and the leg part is installed on the installation target surface.

12. The flying body according to claim 8,
wherein the main body includes a leg part, and the leg part is installed on the installation target surface.
